(19) United States
(12) Patent Application Publication
(10) Pub. No.: US 2026/0323260 A1
(43) Pub. Date: Oct. 15, 2026

(54) REPORTING FLIGHT PATH INFORMATION

(71) Applicant: TELEFONAKTIEBOLAGET LM ERICSSON (PUBL), Stockholm (SE)

(72) Inventors: Helka-Liina Määttänen, Espoo (FI); Hieu Do, Järfälla (SE); Adrián Lahuerta Lavieja, MÖLNDAL (SE); Santhan Thangarasa, VÄLLINGBY (SE); Zhiqiang Qi, BEIJING (CN)

(21) Appl. No.: 19/117,166

(22) PCT Filed: Sep. 18, 2023
(86) PCT No.: PCT/IB2023/059236

§ 371 Date: Mar. 31, 2025

(30) Foreign Application Priority Data
Sep. 29, 2022 (WO) PCT/CN2022/122677

(51) Int. Cl. H04W 4/44; B64U 10/14; B64U 20/80; G08G 5/27

(52) U.S. Cl. CPC H04W 4/44; B64U 10/14; B64U 20/80; G08G 5/27

(57) ABSTRACT

A method performed by an unmanned aerial vehicle (UAV) is disclosed, wherein the UAV includes a wireless communication device (WCD). The method comprises: obtaining reporting condition information which indicates one or more conditions for the UAV to report flight path information, wherein the flight path information indicates a flight path of the UAV. The flight path information includes one or more parameters related to the flight path of the UAV. The one or more reporting conditions for reporting the flight path information are that the one or more parameters have changed more than one or more threshold values within given one or more time intervals.

### TECHNICAL FIELD

Disclosed are embodiments related to methods, apparatus and computer-readable media for reporting flight path information.

### BACKGROUND

### Unmanned Aerial Vehicles (UAV) Communications in the 3rd Generation Partnership Project (3GPP)

The use of drones (a.k.a., UAVs) is becoming increasingly popular. There are numerous use cases of UAVs in industry, such as goods transportation and delivery, surveillance, media production, etc.

Traditionally, a UAV can only be operated by a controller within the UAV's visual line of sight (VLoS). Realizing the great potential of connecting drones beyond visual line of sight (BVLOS) via, for example, a cellular network, the 3GPP has specified multiple features in release 15 (Rel-15) of 3GPP's Long Term Evolution (LTE), aiming at improving the efficiency and robustness of terrestrial LTE networks for providing aerial connectivity services, particularly for low altitude UAVs. These features target both command-and-control traffic for flying the drone and the data (also known as payload) traffic from the drone to the cellular network.

The key features specified include: i) support for subscription-based identification; ii) height reporting when UAV crosses height threshold (the report may include height, location (3D), horizontal and vertical speed); iii) reference signal received power (RSRP) reporting per event of N cells' signal power above a threshold (the report includes RSRP/Reference Signal Received Quality (RSRQ)/location (3D)); iv) user equipment (UE) specific uplink (UL) power control; and v) flight path information provided from an UE to a base station (e.g., evolved node B (eNB). The flight path Information includes network polling, a list of waypoints (3D location), and a list of time stamps if available.

### Flight Path Reporting for UAV in LTE Rel-15

Section 23.17.5 “Flight path information reporting” of a 3GPP Technical Specification (TS) entitled “Evolved Universal Terrestrial Radio Access (E-UTRA) and Evolved Universal Terrestrial Radio Access Network (E-UTRAN); Overall description; Stage 2” (TS 36.300 V17.1.0, available at https://portal.3gpp.org/desktopmodules/Specifications/SpecificationDetails.aspx?specificationId=2430 as of 7 Aug. 2023) (“TS 36.300”) states:

“E-UTRAN can request a UE to report flight path information consisting of a number of waypoints defined as 3D locations as defined in TS 36.355. A UE reports up to configured number of waypoints if flight path information is available at the UE. The report can consist also time stamps per waypoint if configured in the request and if available at the UE.”

The signaling is over the Radio Resource Control (RRC) protocol, as specified in a 3GPP TS entitled “LTE; Evolved Universal Terrestrial Radio Access (E-UTRA); Radio Resource Control (RRC); Protocol specification” (TS 36.331, V17.1.0, available at https://portal.3gpp.org/desktopmodules/Specifications/SpecificationDetails.aspx?specificationId=2440 as of 7 Aug. 2023) (“TS 36.331”). A UE is assumed to receive the flight path plan from unmanned aircraft systems traffic management (UTM) or that it is preconfigured by a user before the flight and hence before an Radio Resource Control (RRC) connection is established.

TS 36.331 defines an information element (IE) (a.k.a., data structure) named “FlightPathInfoReportConfig.” This IE configures the max number of waypoints the UE can report back as well as time stamp (if the network wants). The IEs included in the FlightPathInfoReportConfig are illustrated below in Table 1.

TABLE 1
FlightPathInfoReportConfig IE

```
FlightPathInfoReportConfig-r15 ::= SEQUENCE {
  maxWayPointNumber-r15 INTEGER (1..maxWayPoint-r15),
  includeTimeStamp-r15 ENUMERATED {true} OPTIONAL
}
```

The maxWayPointNumber IE Indicates the maximum number of waypoints the UE can include in the flight path information report if this information is available at the UE. The includeTimeStamp IE indicates whether time stamp of each waypoint can be reported in the flight path information report if time stamp information is available at the UE.

TS 36.331 also defines the flight path information report, which is an IE named “FlightPathInfoReport.” Table 2 below shows the IEs included in the FligthPathInforReport IE.

TABLE 2
FlightPathInfoReport IE

FlightPathInfoReport-r15 ::= SEQUENCE {
flightPath-r15 SEQUENCE (SIZE (1..maxWayPoint-r15)) OF WayPointLocation-r15
}

As shown in Table 2, the flight path information report comprises list of elements of type WayPointLocation, which is defined as shown in Table 3.

TABLE 3
WayPointLocation IE

| | |
|---|---|
| WayPointLocation-r15 ::= | SEQUENCE { |
| wayPointLocation-r15 | LocationInfo-r10, |
| timeStamp-r15 | AbsoluteTimeInfo-r10 OPTIONAL |

}

As shown in Table 3, an element of type WayPointLocation comprises two elements: 1) an element of type LocationInfo and 2) an element of type AbsoluteTimeInfo. The IE LocationInfo is used to transfer detailed location information available at the UE to correlate measurements and UE position information. The definition of the LocationInfo IE is shown below in Table 4

TABLE 4
LocationInfo IE

| | |
|---|---|
| LocationInfo-r10 ::= | SEQUENCE { |
| locationCoordinates-r10 | CHOICE { |
| ellipsoid-Point-r10 | OCTET STRING, |
| ellipsoidPointWithAltitude-r10 | OCTET STRING, |

...,

| | |
|---|---|
| ellipsoidPointWithUncertaintyCircle-r11 | OCTET STRING, |
| ellipsoidPointWithUncertaintyEllipse-r11 | OCTET STRING, |
| ellipsoidPointWithAltitudeAndUncertaintyEllipsoid-r11 | OCTET STRING, |

| | |
|---|---|
| ellipsoidArc-r11 | OCTET STRING, |
| polygon-r11 | OCTET STRING |

},

| | | |
|---|---|---|
| horizontalVelocity-r10 | OCTET STRING | OPTIONAL, |
| gnss-TOD-msec-r10 | OCTET STRING | OPTIONAL, |

...,

| | |
|---|---|
| [[ verticalVelocityInfo-r15 | CHOICE { |
| verticalVelocity-r15 | OCTET STRING, |
| verticalVelocityAndUncertainty-r15 | OCTET STRING |
| } | OPTIONAL |

]]
}

The LocationInfo field descriptions are provided below in Table 5.

TABLE 5
LocationInfo field descriptions

ellipsoidArc
Parameter EllipsoidArc defined in TS 36.355. The first/leftmost bit of the first octet
contains the most significant bit.
ellipsoid-Point
Parameter Ellipsoid-Point defined in TS 36.355. The first/leftmost bit of the first octet
contains the most significant bit.
ellipsoidPointWithAltitude
Parameter EllipsoidPointWithAltitude defined in TS 36.355. The first/leftmost bit of the
first octet contains the most significant bit.
ellipsoidPointWithAltitudeAndUncertaintyEllipsoid
Parameter EllipsoidPointWithAltitudeAndUncertaintyEllipsoid defined in TS 36.355. The
first/leftmost bit of the first octet contains the most significant bit.
ellipsoidPointWithUncertaintyCircle
Parameter Ellipsoid-PointWithUncertaintyCircle defined in TS 36.355. The first/leftmost
bit of the first octet contains the most significant bit.
ellipsoidPointWithUncertaintyEllipse
Parameter EllipsoidPointWithUncertaintyEllipse defined in TS 36.355. The first/leftmost
bit of the first octet contains the most significant bit.
gnss-TOD-msec
Parameter Gnss-TOD-msec defined in TS 36.355. The first/leftmost bit of the first octet
contains the most significant bit.
horizontalVelocity
Parameter HorizontalVelocity defined in TS 36.355. The first/leftmost bit of the first octet
contains the most significant bit.
Polygon
Parameter Polygon defined in TS 36.355. The first/leftmost bit of the first octet contains
the most significant bit.
verticalVelocityAndUncertainty
Parameter verticalVelocityAndUncertainty corresponds to
horizontalWithVerticalVelocityAndUncertainty defined in TS 36.355. The first/leftmost bit
of the first octet contains the most significant bit.
verticalVelocity
Parameter verticalVelocity corresponds to horizontalWithVerticalVelocity defined in TS
36.355. The first/leftmost bit of the first octet contains the most significant bit.

The AbsoluteTimeInfo IE indicates an absolute time in a format YY-MM-DD HH: MM: SS and using Binary Coded Decimal (BCD) encoding. The first/leftmost bit of the bit string contains the most significant bit of the most significant digit of the year and so on. Table 6 below shows the AbsoluteTimeInfo IE.

TABLE 6
AbsoluteTimeInfo IE

| | |
|---|---|
| AbsoluteTimeInfo-r10 ::= | BIT STRING (SIZE (48)) |

### Flight Path Reporting for UAV in Fifth Generation (5G) New Radio (NR)

In RAN #94-e, a new release 18 (Rel-18) Work Item (WI) for supporting UAV in NR was approved in RP-123600 (RP-123600, New WID on NR support for UAV (Uncrewed Aerial Vehicles), RAN #94, December 2021) and one objective is to specify flight path reporting signaling for NR over RRC. The framework of flight path reporting in LTE Rel-15 is the baseline for the Release 18 discussions.

In addition, in Rel-18, 3GPP is also working on a RAN4 work item to support air-to-ground communications (i.e., providing cellular connection to commercial airliners using ground base stations). Among other things, flight path reporting from airplanes to network is also being discussed.

3GPP TS 38.331 V17.1.0 (TS 38.331) specifies the 5G NR RRC protocol. TS 38.331 defines an IE named LocationInfo which is used to transfer available detailed location information, Bluetooth, wireless local-area network (WLAN), and sensor available measurement results at the UE, and which may be used as a starting point for UAV/airplane flight path reporting. Table 7 below shows the definition of the LocationInfo IE.

TABLE 7
LocationInfo IE

| LocationInfo-r16 ::= | SEQUENCE { | |
|---|---|---|
| commonLocationInfo-r16 | CommonLocationInfo-r16 | OPTIONAL, |
| bt-LocationInfo-r16 | LogMeasResultListBT-r16 | OPTIONAL, |
| wlan-LocationInfo-r16 | LogMeasResultListWLAN-r16 | OPTIONAL, |
| sensor-LocationInfo-r16 | Sensor-LocationInfo-r16 | OPTIONAL, |

...
}

The IE CommonLocationInfo is used to transfer detailed location information available at the UE to correlate measurements and UE position information The data type CommonLocationInfo is defined below in Table 8.

TABLE 8
CommonLocationInfo IE

CommonLocationInfo-r16 ::= SEQUENCE {

| | | |
|---|---|---|
| gnss-TOD-msec-r16 | OCTET STRING | OPTIONAL, |
| locationTimestamp-r16 | OCTET STRING | OPTIONAL, |
| locationCoordinate-r16 | OCTET STRING | OPTIONAL, |
| locationError-r16 | OCTET STRING | OPTIONAL, |
| locationSource-r16 | OCTET STRING | OPTIONAL, |
| velocityEstimate-r16 | OCTET STRING | OPTIONAL |

}

The CommonLocationInfo field descriptions are provided below in Table 9.

TABLE 9
CommonLocationInfo field descriptions

gnss-TOD-msec
Parameter type gnss-TOD-msec defined in TS 37.355. The first/leftmost bit of the
first octet contains the most significant bit.
locationTimeStamp
Parameter type DisplacementTimeStamp defined in TS 37.355. The first/leftmost bit
of the first octet contains the most significant bit.
locationCoordinate
Parameter type LocationCoordinates defined in TS 37.355. The first/leftmost bit of
the first octet contains the most significant bit.
locationError
Parameter LocationError defined in TS 37.355. The first/leftmost bit of the first octet
contains the most significant bit.
locationSource
Parameter LocationSource defined in TS 37.355. The first/leftmost bit of the first
octet contains the most significant bit.
velocityEstimate
Parameter type Velocity defined in TS 37.355. The first/leftmost bit of the first octet
contains the most significant bit.

### Unmanned Aircraft Systems (UAS) Traffic Management (UTM)

It is utmost important to keep airspace safe and accessible. Therefore, a system called UTM is being developed in different parts of the world to manage the traffic of the UAS (a UAS is composed of a UAV and a UAV controller used by an operator with unique credentials and identities.) According to the National Aeronautics and Space Administration (NASA), UTM is a collaborative, automated, and federated airspace management approach that enables safe, efficient, and equitable small UAS operations at scale. The concept of UTM is being adopted and implemented by many countries and regions in the world, e.g., in the US, Europe, Japan, Australia, etc.

According to TS 36.300, the UTM provides many flight-related functions for UAVs and UAV operators, including, for example: 1) remote identification: enabling UAV identification; 2) operation planning: flight planning considering various aspects e.g., UAV performance, whether condition; 3) operator messaging: message exchange between operators for e.g., position and status information; 4) Federal Aviation Administration (FAA) messaging: providing on-demand, periodic, or event-triggered communications with FAA systems to meet regulatory requirements; 5) mapping: information about airspace restrictions, obstacles, and sensitive regions; 6) Conflict advisory: real-time alerting for collision avoidance.

Mobile networks can enable reliable connectivity between the UAV and its controller. Meanwhile, UTM can connect to the UAV and the UAV controller through a core network and a radio access network (RAN). An illustration of UAS-to-UTM connectivity is provided in FIG. 6.

### Air-to-Ground (ATG) Communication

In 3GPP terminology, air-to-ground (ATG or A2G) communication refers to the communication between ground base stations and commercial aircraft. Technical solutions for ATG have been implicitly included in 3GPP work on non-terrestrial networks (NTN) in Rel-17. In Rel-18, a RAN4 work item for ATG (RP-220962) is being carried out, which aims to define radio frequency (RF) and radio resource management (RRM) requirements for ATG, having the following scope: 1) Providing in-flight connectivity using ground base stations; 2) Targeting up to 300 km cell coverage and 1200 km/h UE speed; 3) Example bands n1 (FDD), n78 (TDD), and n79 (TDD). In the RRM work, aspects related to flight path reporting from the UE are being discussed.

### SUMMARY

Certain challenges presently exist. For instance, while flight path reporting was specified in LTE, which is used as a baseline for NR UAV WI, there is room for improvement when considering the reporting for NR. A limitation concerns the trigger of the flight path report. In LTE, the flight path report is reported by a UE only if the UE is requested by the network. As a result, the network may not be aware of the latest changes in the flight path which happen in between requests. This can lead to negative impacts on the radio communication to/from the UE, and potentially on the safe and secured operation of the UE as well. Further, in ATG work item, RAN4 has concluded the UE should inform the network on changes in flight path, speed, or altitude.

Accordingly, in one aspect there is provided a method performed by an unmanned aerial vehicle (UAV). The UAV includes a wireless communication device (WCD). The method comprises obtaining reporting condition information which indicates one or more reporting conditions for the UAV to report flight path information, wherein the flight path information indicates a flight path of the UAV. The flight path information includes one or more parameters related to the flight path of the UAV. The one or more reporting conditions for reporting the flight path information are that the one or more parameters have changed more than one or more threshold values within given one or more time intervals.

In another aspect, there is provided a method performed by a network node. The method comprises transmitting towards an unmanned aerial vehicle (UAV) reporting condition information which indicates one or more reporting conditions for the UAV to report flight path information, wherein the flight path information indicates a flight path of the UAV, and the UAV comprises a wireless communication device, WCD, capable of communicating with the network node. The flight path information includes one or more parameters related to the flight path of the UAV. The one or more reporting conditions for reporting the flight path information are that the one or more parameters have changed more than one or more threshold values within given one or more time intervals.

In another aspect, there is provided a computer program comprising instructions which when executed by processing circuitry of an UAV or a network node causes the UAV or the network node to perform the method of any one of the embodiments described above.

In another aspect, there is provided a carrier containing the computer program of the embodiment descried above, wherein the carrier is one of an electronic signal, an optical signal, a radio signal, and a computer readable storage medium.

In another aspect, there is provided an unmanned aerial vehicle (UAV). The UAV includes a wireless communication device (WCD). The UAV is configured to obtain reporting condition information which indicates one or more reporting conditions for the UAV to report flight path information, wherein the flight path information indicates a flight path of the UAV. The flight path information includes one or more parameters related to the flight path of the UAV. The one or more reporting conditions for reporting the flight path information are that the one or more parameters have changed more than one or more threshold values within given one or more time intervals

In another aspect, there is provided a network node. The network node is configured to transmit towards an unmanned aerial vehicle (UAV), reporting condition information which indicates one or more reporting conditions for the UAV to report flight path information, wherein the flight path information indicates a flight path of the UAV. The flight path information includes one or more parameters related to the flight path of the UAV. The one or more reporting conditions for reporting the flight path information are that the one or more parameters have changed more than one or more threshold values within given one or more time intervals. The UAV comprises a wireless communication device, WCD, capable of communicating with the network node.

In another aspect, there is provided an apparatus. The apparatus comprises a processing circuitry; and a memory, said memory containing instructions executable by said processing circuitry, whereby the apparatus is operative to perform the method of any one of embodiments described above.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

It is an object of some embodiments to help improve a network's operational awareness of aerial UEs by means of new report triggering procedures. It is also an object of some embodiments to minimize impacts on radio communication to/from the UE and, potentially, on the safe and secure operation of aerial UEs.

### BRIEF DESCRIPTION OF THE DRAWINGS

The accompanying drawings, which are incorporated herein and form part of the specification, illustrate various embodiments. For a better understanding of the embodiments of the present disclosure, and to show how it may be put into effect, reference will now be made, by way of example only, to the accompanying drawings, in which:

FIG. 1 illustrates a system according to an embodiment;

FIG. 2 shows a process according to an embodiment;

FIG. 3 shows a process according to an embodiment;

FIG. 4 shows an apparatus according to an embodiment;

FIG. 5 shows an apparatus according to an embodiment; and

FIG. 6 shows an illustration of UAS-to-UTM connectivity.

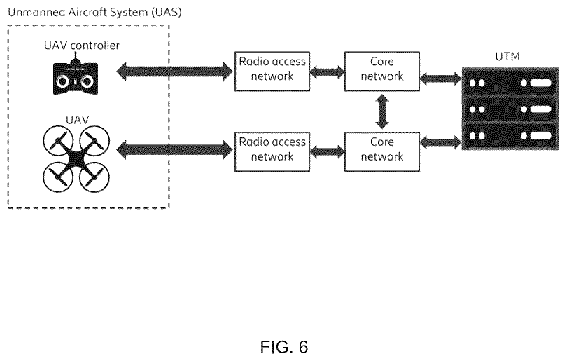

### DETAILED DESCRIPTION

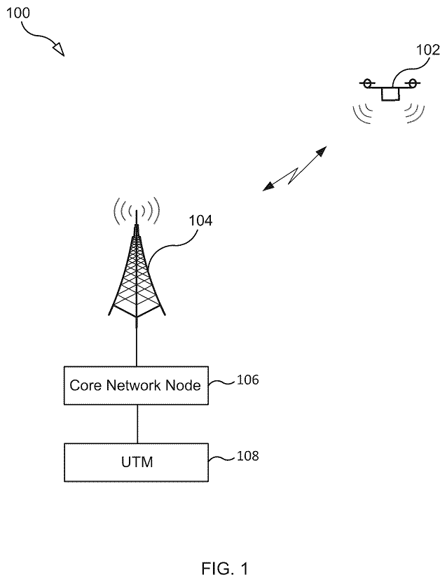

FIG. 1 illustrates a part of a system 100 according to an embodiment. System 100 includes an unmanned aerial vehicle (UAV) 102, a radio access network (RAN) node 104, and a core network node 106, and an unmanned aircraft systems (UAS) traffic management (UTM) entity 108.

UAV 102 may include a wireless communication device that is capable of communicating with RAN node 104. UAV 102 is connected to UTM 108 via RAN node 104 and core network node 106. UTM 108 is configured to manage the traffic of UAV 102.

As discussed above, there is a need to trigger UAV 102 to transmit towards RAN node 104 flight path information indicating UAV 102's flight path. Transmitting towards UAV 102 a reporting request for reporting the flight path information is one way. However, in some scenarios, it may be desirable for UAV 102 to report the flight path information based on an occurrence of one or more reporting conditions (e.g., when an altitude of UAV 102 suddenly drops).

Accordingly, in some embodiments, RAN node 104 may transmit towards UAV 102 reporting condition information. The reporting condition information indicates one or more conditions for UAV 102 to report to RAN node 104 and/or core network node 106 flight path information indicating a flight path of UAV 102.

For example, the reporting condition information may indicate a condition #1 and a condition #2. UAV 102 may be configured to report the flight path information only when the conditions #1 and #2 are satisfied or to report the flight path information when either the condition #1 or the condition #2 is satisfied. In another example, the reporting condition information may indicate a condition #1, a condition #2, and a condition #3. In this example, UAV 102 may be configured to report the flight path information only when (1) the condition #1 is satisfied and (2) either the condition #2 or #3 is satisfied. In a summary, in case the reporting condition information indicates more than one condition, some of the conditions may be a required condition (meaning that unless this condition is satisfied, UAV 102 may not report the flight path information) while some of the conditions may be an alternative condition (meaning that even if this condition is not satisfied, if another condition(s) is satisfied, UAV 102 may report the flight path information).

In some embodiments, the reporting condition information may also indicate that said one or more conditions are valid only for certain time interval(s). For example, the reporting condition information may indicate that a condition #1 is valid only for a time interval #1 while a condition #2 is valid only for a time interval #2. In another example, the reporting condition may indicate that conditions #1 and #2 are valid only for a time interval #3.

The reporting condition information may be included in a radio resource control (RRC) reconfiguration message and/or system information (SI) which RAN node 104 is configured to transmit towards UAV 102.

In some embodiments, the flight path information includes one or more parameters related to the flight path of UAV 102. For example, the flight path information may indicate one or more of: an altitude of UAV 102, a speed of UAV 102, a remaining battery level of UAV 102 (and/or a remaining battery level of a component included in UAV 102), or a location of UAV 102.

In some embodiments, the one or more conditions for reporting the flight path information are that one or more of these parameters of the flight path information has changed more than threshold value(s). For example, if the flight path information includes a value of a parameter #1 and a value of parameter #2, the reporting condition information may indicate that UAV 102 needs to report the flight path information if the value of parameter #1 has changed more than a threshold value #1 and/or the value of parameter #2 has changed more than a threshold value #2. This detection of the change of the value(s) of the parameter(s) may be performed via a direct measurement or may be an estimation.

In some embodiments, the reporting condition information may also indicate a time interval during which the condition needs to be satisfied in order to trigger UAV 102 to report the flight path information. For example, the reporting condition information may indicate that UAV 102 needs to report the flight path information if the value of parameter #1 has changed more than a threshold value #1 within a time interval #1.

In one example, the condition for triggering the reporting is that the altitude of UAV 102 has changed more than P % or more than M meters within N seconds. In another example, the condition for triggering the reporting is that the speed of UAV 102 has changed more than P % within N seconds or that the location of UAV 102 has changed more than M meters within N seconds. In further example, the condition for triggering the reporting is that a battery level of UAV 102 or a battery level of a particular component within UAV 102 has changed more than P % within N seconds.

Here, “P,” “M,” and “N” correspond to threshold values for triggering the reporting of the flight path information. These threshold values may be predefined or may be configurable by RAN 104, core network node 106, or any other network entity. The threshold values may be expressed in different units. For example, “P” may be expressed in absolute units (e.g., %, kilometers, degrees, etc.) and N may be expressed in terms of symbols, slots, subframes, etc.

In some embodiments, in addition to or instead of the condition(s) discussed above, there may be one or more additional conditions for triggering UAV 102 to report the flight path information. The additional condition(s) comprises one or more of that:
There is a change in a radio condition (e.g., a signal-to-noise ratio (SNR) or a signal-to-interference and noise ratio (SINR) has changed by more than X dB over last N time units, where X and N are predefined or configurable).
UAV 102 has detected K1 out-of-sync indication (may define the entering condition of an event) or K2 in-sync indication (may define the leaving condition for an event),
A radio link failure (RLF) timer has started,
UAV 102 has detected a beam failure detection, BFD,
UAV 102 has switched its measurement mode, or
UAV 102 has detected equipment failure or malfunctioning at UAV 102.

The measurement mode may be one of a relaxed measurement mode or a reference measurement mode. A measurement period of the relaxed measurement mode may be longer than a measurement period of the reference measurement mode. Additionally or alternatively, in the relaxed measurement mode, no measurement is performed for any neighboring cells and/or measurement is performed on a first number of carriers while, in the reference measurement mode, measurement is performed for one or more neighboring cells (e.g., all detected neighbor cells) and/or measurement is performed on a second number of carriers (e.g., all configured carriers), where the first number is less than the second number.

For many use cases, this type of event-triggered report can help the network (e.g., RAN node 104, core network node 106, etc.) to detect anomalies in the flight status and upon detecting the anomalies, the network can trigger actions such as informing UTM 108 or the traditional air traffic management system to take safety or security measures.

The triggering mechanism in the above described embodiments may be defined similar to the current radio resource management (RRM) events in TS 38.331 which are configured for an user equipment (UE) by IE measurement object. Similarly, a flight path reporting event may include a time for triggering the reporting (which means the reporting condition is valid for a configured amount of time). There are also provided a hysteresis to avoid ping pong triggering as well as reportOnleave, that enables the network to configure if the UE should report when the leaving condition of the event is fulfilled.

In some embodiments, UAV 102 may be configured to transmit new flight path information to the network (e.g., RAN node 104 or core network node 106) only when the change in at least one of the parameters related to the flight path of UAV 102 exceeds a certain predetermined threshold (e.g., pre-defined in the specifications, pre-configured in a SIM card, or configured by the network).

If the change does not exceed the threshold, in some embodiments, UAV 102 may be configured to transmit to the network (e.g., RAN node 104 or core network node 106) only an indication message indicating that the flight path of UAV 102 has changed. In such embodiments, upon receiving the indication message, it is up to the network (e.g., RAN node 104 or core network node 106) to decide whether to request UAV 102 to transmit to the network new flight path information. By configuring UAV 102 to only transmit the indication message when the change is less than the threshold value, the use of the amount of uplink data generated by flight path reports can be minimized while important changes in the flight path (such as a sudden drop of aircraft's altitude) can be observed by the network with minimum delay.

In some embodiments, a network entity (e.g., RAN node 104, core network node 106, etc.) may inform UAV 102 about one or more changes in the flight operational data upon which UAV 102 triggers a report (i.e., transmitting flight path information). In these embodiments, it is assumed the network entity has obtained information related to changes in flight data from a network node such as UTM 108 or the traditional air traffic management system.

Information conveyed in the report from UAV 102 to the network entity may comprise one or more parameters indicating the radio conditions, such as measurements (e.g., signal strength measurements, signal quality measurements), state of the connection (e.g., in-sync, out-of-sync), detected beams, neighbor cells, etc.

In some embodiments, UAV 102 may be configured to transmit to the network a new flight report (a.k.a., new flight path information) when a battery level of UAV 102 or a battery level of a particular component of UAV 102 falls below a certain threshold. The threshold may be configured by a network node (e.g., RAN node 104, core network node 106) or may be preconfigured. The information included in the new flight report which is triggered by the change of the battery level may trigger the starting of an emergency landing procedure could be started.

Additionally or alternatively, UAV 102 may be configured to transit to the network a new flight path report (a.k.a., new flight path information) when UAV 102 detects equipment failure or malfunctioning (e.g., mechanical, electrical, temperature-related (overheating) malfunctioning, etc.). This equipment failure/malfunctioning reporting may be of importance to minimize potential damages to, for example, human beings, infrastructure.

In some embodiments, in order to avoid excessive flight path report (i.e., excessive transmission of flight path information) and to reduce the power consumption, UAV 102 may be configured to consider battery information of UAV 102 (e.g., a battery level of UAV 102 and/or a battery level of a component of UAV 102) while triggering flight path reporting. For example, in case the reporting condition information indicates that UAV 102 needs to report the flight path information if a condition #1 is satisfied, UAV 102 may not be triggered to report the flight path information if the remaining battery level of UAV is less than 10%.

In some embodiments, all or some possible triggering reasons (conditions) of flight path report may be assigned to corresponding priorities. Then, by considering the trade-off between the priority of a triggering condition and the battery information, whether to trigger the flight path reporting can be decided.

For example, if the priority level of a triggering condition (a.k.a., triggering reason #1) is high (e.g., in case of emergency or security issue), transmission of the flight path report may be triggered regardless of the batter information (e.g., without considering the battery information). On the other hand, if the priority level of a triggering condition is medium or low, transmission of the flight path report may only be triggered if the remaining battery level is higher than a certain threshold value.

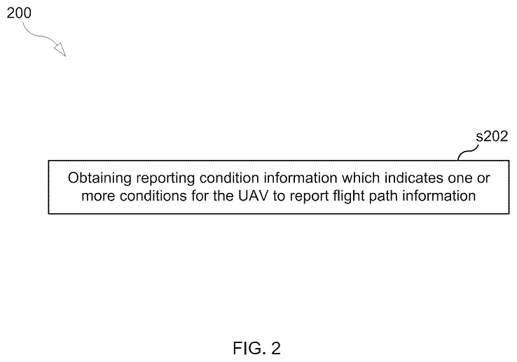

FIG. 2 shows a process 200 performed by an unmanned aerial vehicle (UAV) 102. The UAV includes a wireless communication device (WCD). Process 200 comprises step s202. Step s202 comprises obtaining reporting condition information which indicates one or more reporting conditions for the UAV to report flight path information. The flight path information indicates a flight path of the UAV.

In some embodiments, process 200 may comprise determining whether said one or more reporting conditions are satisfied; and at least based on determining that said one or more reporting conditions are satisfied, transmitting towards a network node the flight path information.

In some embodiments, process 200 may comprise determining whether said one or more reporting conditions are satisfied; and at least based on determining that said one or more reporting conditions are not satisfied, transmitting towards a network node an indication message indicating that the flight path of the UAV has changed.

In some embodiments, process 200 may comprise after transmitting the indication message towards the network node, receiving a reporting request for reporting the flight path information; and at least based on receiving the reporting request, transmitting towards the network node the flight path information.

In some embodiments, the reporting condition information indicates that said one or more reporting conditions are valid only for a certain time interval.

In some embodiments, the flight path information includes one or more parameters related to the flight path of the UAV, and said one or more reporting conditions for reporting the flight path information are that said one or more parameters have changed more than one or more threshold values.

In some embodiments, said one or more reporting conditions for reporting the flight path information are that said one or more parameters have changed more than said one or more threshold values within given one or more time intervals.

In some embodiments, said one or more parameters include one or more of: an altitude of the UAV, a speed of the UAV, a remaining battery level of the UAV, a remaining battery level of the WCD, or a location of the UAV.

In some embodiments, the flight path information is transmitted towards the network node further based on whether one or more additional reporting conditions is satisfied, and said one or more additional reporting conditions comprises one or more of that: a radio condition parameter has changed more than a threshold value, the WCD has detected K1 out-of-sync indication or K2 in-sync indication, a radio link failure, RLF, timer has started, the WCD has detected a beam failure detection, BFD, the WCD has switched its measurement mode, or the WCD has detected equipment failure or malfunctioning at the UAV.

In some embodiments, the radio condition parameter is a signal-to-noise ratio, SNR, or a signal-to-interference and noise ratio, SINR.

In some embodiments, the measurement mode is one of a relaxed measurement mode or a reference measurement mode, and (i) a measurement period of the relaxed measurement mode is longer than a measurement period of the reference measurement mode, (ii) in the relaxed measurement mode, no measurement is performed for any neighboring cells and/or measurement is performed on a first number of carriers while, in the reference measurement mode, measurement is performed for one or more neighboring cells and/or measurement is performed on a second number of carriers, where the first number is less than the second number.

In some embodiments, the flight path information indicates that at least some data included in the flight path information is valid only for a certain time interval.

In some embodiments, obtaining the reporting condition information comprises receiving a radio resource control, RRC, reconfiguration message and/or system information, SI, and the RRC reconfiguration message and/or the SI include the reporting condition information, and the RRC reconfiguration message and/or the SI were transmitted by a network node.

In some embodiments, process 200 may comprise obtaining restriction condition information indicating one or more restriction conditions for restricting the UAV from reporting the flight path information; and based on the restriction condition information, determining whether to transmit towards a network node the flight path information.

In some embodiments, each of said one or more reporting conditions is assigned to a priority level, and whether to transmit the flight path information is determined further based on the priority level.

In some embodiments, said one or more reporting conditions comprises a first reporting condition and/or a second reporting condition, the first reporting condition is assigned to a first priority level, the second reporting condition is assigned to a second priority level that is lower than the first priority level, the method comprises: determining that said one or more restriction conditions are satisfied; determining whether the first condition and/or the second condition is satisfied; and in case the first condition is satisfied, transmitting towards the network node the flight path information but in case the first condition is not satisfied, regardless of whether the second condition is satisfied, not transmitting towards the network node the flight path information.

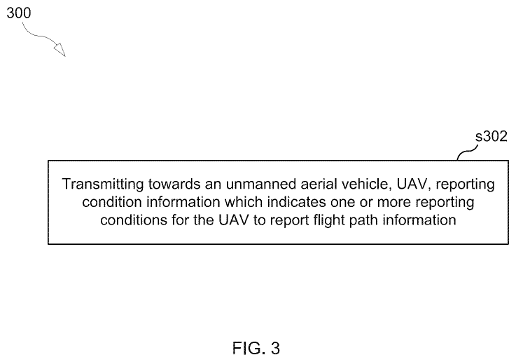

FIG. 3 shows a process 300 performed by RAN node 104, a core network node 106, or any other network entity. Process 300 comprises step s302. Step s302 comprises transmitting towards an unmanned aerial vehicle (UAV) 102 reporting condition information which indicates one or more reporting conditions for the UAV to report flight path information. The flight path information indicates a flight path of the UAV, and the UAV comprises a wireless communication device (WCD) capable of communicating with the network node.

In some embodiments, process 300 comprises receiving the flight path information, wherein the flight path information was transmitted by the UAV based at least on that said one or more reporting conditions are satisfied.

In some embodiments, process 300 comprises receiving an indication message indicating that the flight path of the UAV has changed, wherein the indication message was transmitted by the UAV based at least on that said one or more reporting conditions are not satisfied.

In some embodiments, process 300 comprises after receiving the indication message, transmitting towards the UAV a reporting request for reporting the flight path information; and at least based on transmitting the reporting request, receiving the flight path information, wherein the flight path information was transmitted by the UAV.

In some embodiments, the reporting condition information indicates that said one or more reporting conditions are valid only for a certain time interval.

In some embodiments, the flight path information includes one or more parameters related to the flight path of the UAV, and said one or more reporting conditions for reporting the flight path information are that said one or more parameters have changed more than one or more threshold values.

In some embodiments, said one or more reporting conditions for reporting the flight path information are that said one or more parameters have changed more than said one or more threshold values within given one or more time intervals.

In some embodiments, said one or more parameters include one or more of: an altitude of the UAV, a speed of the UAV, a remaining battery level of the UAV, or a location of the UAV.

In some embodiments, the flight path information was transmitted by the UAV further based on that one or more additional reporting conditions are satisfied, and said one or more additional reporting conditions comprises one or more of that: a radio condition parameter has changed more than a threshold value, the WCD has detected K1 out-of-sync indication or K2 in-sync indication, a radio link failure, RLF, timer has started, the WCD has detected a beam failure detection, BFD, the WCD has switched its measurement mode, or the WCD has detected equipment failure or malfunctioning at the UAV.

In some embodiments, the radio condition parameter is a signal-to-noise ratio, SNR, or a signal-to-interference and noise ratio, SINR.

In some embodiments, the measurement mode is one of a relaxed measurement mode or a reference measurement mode, and (i) a measurement period of the relaxed measurement mode is longer than a measurement period of the reference measurement mode, (ii) in the relaxed measurement mode, no measurement is performed for any neighboring cells and/or measurement is performed on a first number of carriers while, in the reference measurement mode, measurement is performed for one or more neighboring cells and/or measurement is performed on a second number of carriers, where the first number is less than the second number.

In some embodiments, the flight path information indicates that at least some data included in the flight path information is valid only for a certain time interval.

In some embodiments, transmitting the reporting condition information comprises transmitting a radio resource control, RRC, reconfiguration message and/or system information, SI, and the RRC reconfiguration message and/or the SI includes the reporting condition information.

In some embodiments, process 300 comprises transmitting towards the UAV restriction condition information indicating one or more restriction conditions for restricting the UAV from reporting the flight path information, wherein whether to transmit the flight path information from the UAV is determined based on the restriction condition information.

In some embodiments, each of said one or more reporting conditions is assigned to a priority level, and whether to transmit the flight path information from the UAV is determined further based on the priority level.

In some embodiments, said one or more reporting conditions comprises a first reporting condition and/or a second reporting condition, the first reporting condition is assigned to a first priority level, the second reporting condition is assigned to a second priority level that is lower than the first priority level, in case (i) said one or more restriction conditions are satisfied and (ii) the first condition is satisfied, the flight path information is transmitted towards the network node, but in case (i) said one or more restriction conditions are satisfied and (ii) the first condition is not satisfied, regardless of whether the second condition is satisfied, the flight path information is not transmitted towards the network node.

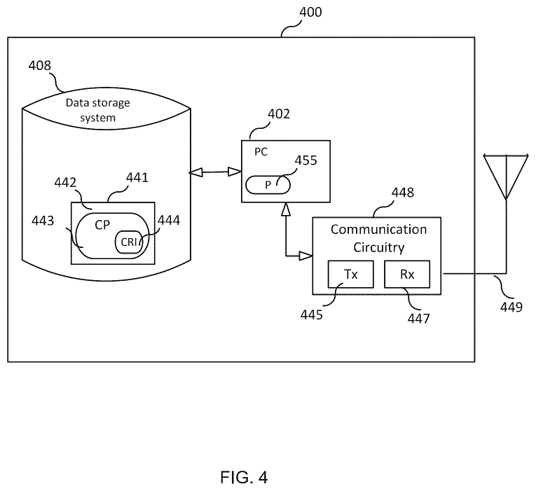

FIG. 4 is a block diagram of the WCD included in UAV 102, according to some embodiments. As shown in FIG. 4, the WCD may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like); communication circuitry 448, which is coupled to an antenna arrangement 449 comprising one or more antennas and which comprises a transmitter (Tx) 445 and a receiver (Rx) 447 for enabling UE 102 to transmit data and receive data (e.g., wirelessly transmit/receive data); and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes UE 102 to perform steps described herein (e.g., steps described herein with reference to the flow charts). In other embodiments, UE 102 may be configured to perform steps described herein without the need for code. That is, for example, PC 402 may consist merely of one or more ASICs. Hence, the features of the embodiments described herein may be implemented in hardware and/or software.

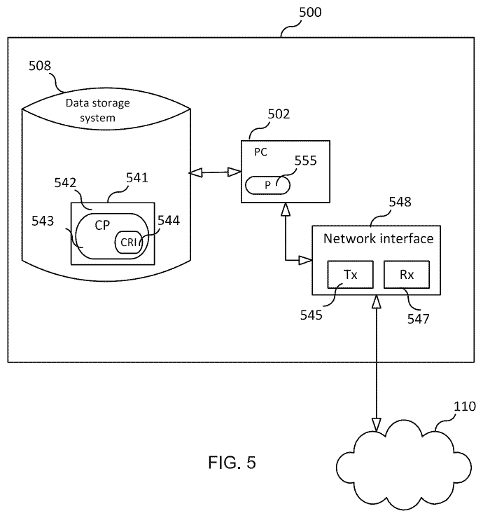

FIG. 5 is a block diagram of network node 500 (e.g., RAN node 104), according to some embodiments. As shown in FIG. 5, network node 500 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 500 may be a distributed computing apparatus); at least one network interface 548 (e.g., a physical interface or air interface) comprising a transmitter (Tx) 545 and a receiver (Rx) 547 for enabling network node 500 to transmit data to and receive data from other nodes connected to a network 110 (e.g., an Internet Protocol (IP) network) to which network interface 548 is connected (physically or wirelessly) (e.g., network interface 548 may be coupled to an antenna arrangement comprising one or more antennas for enabling network node 500 to wirelessly transmit/receive data); and a storage unit (a.k.a., “data storage system”) 508, which may include one or more non-volatile storage devices and/or one or more volatile storage devices. In embodiments where PC 502 includes a programmable processor, a computer readable storage medium (CRSM) 542 may be provided. CRSM 542 may store a computer program (CP) 543 comprising computer readable instructions (CRI) 544. CRSM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes network node 500 to perform steps described herein (e.g., steps described herein with reference to the flow charts). In other embodiments, network node 500 may be configured to perform steps described herein without the need for code. That is, for example, PC 502 may consist merely of one or more ASICs. Hence, the features of the embodiments described herein may be implemented in hardware and/or software.

For the avoidance of doubt, the following numbered statements provide additional information on the disclosure.

A1. A method (200) performed by an unmanned aerial vehicle, UAV (102), the UAV including a wireless communication device, WCD, the method comprising:
obtaining (s202) reporting condition information which indicates one or more conditions for the UAV to report flight path information, wherein
the flight path information indicates a flight path of the UAV.

A2. The method of statement A1, comprising:
determining whether said one or more reporting conditions are satisfied; and
at least based on determining that said one or more reporting conditions are satisfied, transmitting towards a network node the flight path information.

A3. The method of statement A1, comprising:
determining whether said one or more reporting conditions are satisfied; and
at least based on determining that said one or more reporting conditions are not satisfied, transmitting towards a network node an indication message indicating that the flight path of the UAV has changed.

A4. The method of statement A3, comprising:
after transmitting the indication message towards the network node, receiving a reporting request for reporting the flight path information; and
at least based on receiving the reporting request, transmitting towards the network node the flight path information.

A5. The method of any one of statements A1-A4, wherein the reporting condition information indicates that said one or more reporting conditions are valid only for a certain time interval.

A6. The method of any one of statements A1-A5, wherein
the flight path information includes one or more parameters related to the flight path of the UAV, and
said one or more reporting conditions for reporting the flight path information are that said one or more parameters have changed more than one or more threshold values.

A7. The method of statement A6, wherein said one or more reporting conditions for reporting the flight path information are that said one or more parameters have changed more than said one or more threshold values within given one or more time intervals.

A8. The method of statement A6 or A7, wherein said one or more parameters include one or more of: an altitude of the UAV, a speed of the UAV, a remaining battery level of the UAV, a remaining battery level of the WCD, or a location of the UAV.

A9. The method of any one of statements A2 and A5-A8 (when A5-A8 depend on A2), wherein the flight path information is transmitted towards the network node further based on whether one or more additional reporting conditions is satisfied, and
said one or more additional reporting conditions comprises one or more of that:
   a radio condition parameter has changed more than a threshold value,
   the WCD has detected K1 out-of-sync indication or K2 in-sync indication,
   a radio link failure, RLF, timer has started,
   the WCD has detected a beam failure detection, BFD,
   the WCD has switched its measurement mode, or
   the WCD has detected equipment failure or malfunctioning at the UAV.

A10. The method of statement A9, wherein the radio condition parameter is a signal-to-noise ratio, SNR, or a signal-to-interference and noise ratio, SINR.

A11. The method of statement A9 or A10, wherein
the measurement mode is one of a relaxed measurement mode or a reference measurement mode, and
(i) a measurement period of the relaxed measurement mode is longer than a measurement period of the reference measurement mode, (ii) in the relaxed measurement mode, no measurement is performed for any neighboring cells and/or measurement is performed on a first number of carriers while, in the reference measurement mode, measurement is performed for one or more neighboring cells and/or measurement is performed on a second number of carriers, where the first number is less than the second number.

A12. The method of any one of statements A1-A11, wherein the flight path information indicates that at least some data included in the flight path information is valid only for a certain time interval.

A13. The method of any one of statements A1-A12, wherein
obtaining the reporting condition information comprises receiving a radio resource control, RRC, reconfiguration message and/or system information, SI, and
the RRC reconfiguration message and/or the SI include the reporting condition information, and
the RRC reconfiguration message and/or the SI were transmitted by a network node.

A14. The method of any one of statements A1-A13, comprising:
obtaining restriction condition information indicating one or more restriction conditions for restricting the UAV from reporting the flight path information; and
based on the restriction condition information, determining whether to transmit towards a network node the flight path information.

A15. The method of statement A14, wherein
each of said one or more reporting conditions is assigned to a priority level, and
whether to transmit the flight path information is determined further based on the priority level.

A16. The method of statement A15, wherein
said one or more reporting conditions comprises a first reporting condition and/or a second reporting condition,
the first reporting condition is assigned to a first priority level,
the second reporting condition is assigned to a second priority level that is lower than the first priority level,
the method comprises:
   determining that said one or more restriction conditions are satisfied;
   determining whether the first condition and/or the second condition is satisfied; and
   in case the first condition is satisfied, transmitting towards the network node the flight path information
   in case the first condition is not satisfied, regardless of whether the second condition is satisfied, not transmitting towards the network node the flight path information.

B1. A method (300) performed by a network node (e.g., 104 or 106), the method comprising:
transmitting (s302) towards an unmanned aerial vehicle, UAV (102), reporting condition information which indicates one or more reporting conditions for the UAV to report flight path information, wherein
the flight path information indicates a flight path of the UAV, and
the UAV comprises a wireless communication device, WCD, capable of communicating with the network node.

B2. The method of statement B1, comprising:
receiving the flight path information, wherein
the flight path information was transmitted by the UAV based at least on that said one or more reporting conditions are satisfied.

B3. The method of statement B1, comprising:
receiving an indication message indicating that the flight path of the UAV has changed, wherein
the indication message was transmitted by the UAV based at least on that said one or more reporting conditions are not satisfied.

B4. The method of statement B3, comprising:
after receiving the indication message, transmitting towards the UAV a reporting request for reporting the flight path information; and
at least based on transmitting the reporting request, receiving the flight path information, wherein
the flight path information was transmitted by the UAV.

B5. The method of any one of statements B1-B4, wherein the reporting condition information indicates that said one or more reporting conditions are valid only for a certain time interval.

B6. The method of any one of statements B1-B5, wherein
the flight path information includes one or more parameters related to the flight path of the UAV, and
said one or more reporting conditions for reporting the flight path information are that said one or more parameters have changed more than one or more threshold values.

B7. The method of statement B6, wherein said one or more reporting conditions for reporting the flight path information are that said one or more parameters have changed more than said one or more threshold values within given one or more time intervals.

B8. The method of statement B6 or B7, wherein said one or more parameters include one or more of: an altitude of the UAV, a speed of the UAV, a remaining battery level of the UAV, or a location of the UAV.

B9. The method of any one of statements B2 and B5-B8 (when B5-B8 depend on B2), wherein
the flight path information was transmitted by the UAV further based on that one or more additional reporting conditions are satisfied, and
said one or more additional reporting conditions comprises one or more of that:
   a radio condition parameter has changed more than a threshold value,
   the WCD has detected K1 out-of-sync indication or K2 in-sync indication,
   a radio link failure, RLF, timer has started,
   the WCD has detected a beam failure detection, BFD,
   the WCD has switched its measurement mode, or
   the WCD has detected equipment failure or malfunctioning at the UAV.

B10. The method of statement B9, wherein the radio condition parameter is a signal-to-noise ratio, SNR, or a signal-to-interference and noise ratio, SINR.

B11. The method of statement B9 or B10, wherein
the measurement mode is one of a relaxed measurement mode or a reference measurement mode, and
(i) a measurement period of the relaxed measurement mode is longer than a measurement period of the reference measurement mode, (ii) in the relaxed measurement mode, no measurement is performed for any neighboring cells and/or measurement is performed on a first number of carriers while, in the reference measurement mode, measurement is performed for one or more neighboring cells and/or measurement is performed on a second number of carriers, where the first number is less than the second number.

B12. The method of any one of statements B1-B11, wherein the flight path information indicates that at least some data included in the flight path information is valid only for a certain time interval.

B13. The method of any one of statements B1-B12, wherein
transmitting the reporting condition information comprises transmitting a radio resource control, RRC, reconfiguration message and/or system information, SI, and
the RRC reconfiguration message and/or the SI includes the reporting condition information.

B14. The method of any one of statements B1-B13, comprising:
transmitting towards the UAV restriction condition information indicating one or more restriction conditions for restricting the UAV from reporting the flight path information, wherein
whether to transmit the flight path information from the UAV is determined based on the restriction condition information.

B15. The method of statement B14, wherein
each of said one or more reporting conditions is assigned to a priority level, and
whether to transmit the flight path information from the UAV is determined further based on the priority level.

B16. The method of statement B15, wherein
said one or more reporting conditions comprises a first reporting condition and/or a second reporting condition,
the first reporting condition is assigned to a first priority level,
the second reporting condition is assigned to a second priority level that is lower than the first priority level,
in case (i) said one or more restriction conditions are satisfied and (ii) the first condition is satisfied, the flight path information is transmitted towards the network node, and
in case (i) said one or more restriction conditions are satisfied and (ii) the first condition is not satisfied, regardless of whether the second condition is satisfied, the flight path information is not transmitted towards the network node.

C1. A computer program (443 or 543) comprising instructions (444 or 544) which when executed by processing circuitry (402 or 502) of an UAV or a network node causes the UAV or the network node to perform the method of any one of the statements A1-B16.

C2. A carrier containing the computer program of statement C1, wherein the carrier is one of an electronic signal, an optical signal, a radio signal, and a computer readable storage medium (442 or 542).

D1. An unmanned aerial vehicle, UAV (102), the UAV including a wireless communication device, WCD, the UAV being configured to:
obtain (s202) reporting condition information which indicates one or more conditions for the UAV to report flight path information, wherein
the flight path information indicates a flight path of the UAV.

D2. The UAV of statement D1, wherein the UAV is configured to perform the method of any one of statements A2-A16.

E1. A network node (e.g., 104 or 106), the network node being configured to:
transmit (s302) towards an unmanned aerial vehicle, UAV (102), reporting condition information which indicates one or more conditions for the UAV to report flight path information, wherein
the flight path information indicates a flight path of the UAV, and
the UAV comprises a wireless communication device, WCD, capable of communicating with the network node.

E2. The network node of statement E1, wherein the network node is configured to perform the method of any one of statements B2-B16.

F1. An apparatus (200 or 300) comprising:
a processing circuitry (202 or 302); and
a memory (241 or 341), said memory containing instructions executable by said processing circuitry, whereby the apparatus is operative to perform the method of any one of statements A1-B16.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by an unmanned aerial vehicle, UAV, the UAV including a wireless communication device, WCD, the method comprising:
obtaining reporting condition information which indicates one or more conditions for the UAV to report flight path information, wherein
the flight path information indicates a flight path of the UAV and includes one or more parameters related to the flight path of the UAV, and wherein said one or more reporting conditions for reporting the flight path information are that said one or more parameters have changed more than one or more threshold values within given one or more time intervals.

2. The method of claim 1, wherein the reporting condition information indicates that said one or more reporting conditions are valid only for a certain time interval.

3. The method of claim 1, wherein said one or more parameters include one or more of: an altitude of the UAV, a speed of the UAV, a remaining battery level of the UAV, a remaining battery level of the WCD, or a location of the UAV.

4. The method of any one of claim 1, comprising:
determining whether said one or more reporting conditions are satisfied; and
at least based on determining that said one or more reporting conditions are satisfied, transmitting towards a network node the flight path information.

5. The method of claim 1, comprising:
determining whether said one or more reporting conditions are satisfied; and
at least based on determining that said one or more reporting conditions are not satisfied, transmitting towards a network node an indication message indicating that the flight path of the UAV has changed.

6. The method of claim 5, comprising:
after transmitting the indication message towards the network node, receiving a reporting request for reporting the flight path information; and
at least based on receiving the reporting request, transmitting towards the network node the flight path information.

7. The method of claim 4, wherein the flight path information is transmitted towards the network node further based on whether one or more additional reporting conditions is satisfied, and
said one or more additional reporting conditions comprises one or more of that:
a radio condition parameter has changed more than a threshold value and, optionally, wherein the radio condition parameter is a signal-to-noise ratio, SNR, or a signal-to-interference and noise ratio, SINR,
the WCD has detected K1 out-of-sync indication or K2 in-sync indication,
a radio link failure, RLF, timer has started,
the WCD has detected a beam failure detection, BFD,
the WCD has switched its measurement mode, or
the WCD has detected equipment failure or malfunctioning at the UAV.

8.-10. (canceled)

11. The method of claim 1, comprising:
obtaining restriction condition information indicating one or more restriction conditions for restricting the UAV from reporting the flight path information; and
based on the restriction condition information, determining whether to transmit towards a network node the flight path information.

12. (canceled)

13. The method of claim 11, wherein
each of said one or more reporting conditions is assigned to a priority level;
whether to transmit the flight path information is determined further based on the priority level; and
said one or more reporting conditions comprises a first reporting condition and/or a second reporting condition,
the first reporting condition is assigned to a first priority level,
the second reporting condition is assigned to a second priority level that is lower than the first priority level,
the method comprises:
determining that said one or more restriction conditions are satisfied;
determining whether the first condition and/or the second condition is satisfied; and
in case the first condition is satisfied, transmitting towards the network node the flight path information
in case the first condition is not satisfied, regardless of whether the second condition is satisfied, not transmitting towards the network node the flight path information.

14. A method performed by a network node (e.g., 104 or 106), the method comprising:
transmitting towards an unmanned aerial vehicle, UAV, reporting condition information which indicates one or more reporting conditions for the UAV to report flight path information, wherein
the flight path information indicates a flight path of the UAV and includes one or more parameters related to the flight path of the UAV, and wherein said one or more reporting conditions for reporting the flight path information are that said one or more parameters have changed more than one or more threshold values within given one or more time intervals, and
the UAV comprises a wireless communication device, WCD, capable of communicating with the network node.

15. The method of claim 14, wherein the reporting condition information indicates that said one or more reporting conditions are valid only for a certain time interval.

16. The method of claim 14, wherein said one or more parameters include one or more of: an altitude of the UAV, a speed of the UAV, a remaining battery level of the UAV, or a location of the UAV.

17. The method of claim 14, comprising:
receiving the flight path information, wherein
the flight path information was transmitted by the UAV based at least on that said one or more reporting conditions are satisfied.

18. (canceled)

19. The method of claim 14, comprising:
receiving an indication message indicating that the flight path of the UAV has changed, wherein the indication message was transmitted by the UAV based at least on that said one or more reporting conditions are not satisfied;
after receiving the indication message, transmitting towards the UAV a reporting request for reporting the flight path information; and
at least based on transmitting the reporting request, receiving the flight path information, wherein the flight path information was transmitted by the UAV.

20. The method of claim 17, wherein
the flight path information was transmitted by the UAV further based on that one or more additional reporting conditions are satisfied, and
said one or more additional reporting conditions comprises one or more of that:
a radio condition parameter has changed more than a threshold value and, optionally, wherein the radio condition parameter is a signal-to-noise ratio, SNR, or a signal-to-interference and noise ratio, SINR,
the WCD has detected K1 out-of-sync indication or K2 in-sync indication,
a radio link failure, RLF, timer has started,
the WCD has detected a beam failure detection, BFD,
the WCD has switched its measurement mode, or
the WCD has detected equipment failure or malfunctioning at the UAV.

21.-23. (canceled)

24. The method of claim 14, comprising:
transmitting towards the UAV restriction condition information indicating one or more restriction conditions for restricting the UAV from reporting the flight path information, wherein
whether to transmit the flight path information from the UAV is determined based on the restriction condition information.

25. (canceled)

26. The method of claim 24, wherein
each of said one or more reporting conditions is assigned to a priority level to be used to determine whether to transmit the flight path information from the UAV; and
said one or more reporting conditions comprises a first reporting condition and/or a second reporting condition,
the first reporting condition is assigned to a first priority level,
the second reporting condition is assigned to a second priority level that is lower than the first priority level,
in case (i) said one or more restriction conditions are satisfied and (ii) the first condition is satisfied, the flight path information is transmitted towards the network node, and
in case (i) said one or more restriction conditions are satisfied and (ii) the first condition is not satisfied, regardless of whether the second condition is satisfied, the flight path information is not transmitted towards the network node.

27. (canceled)

28. An unmanned aerial vehicle, UAV, the UAV including a wireless communication device, WCD, the UAV being configured to:
obtain reporting condition information which indicates one or more conditions for the UAV to report flight path information, wherein
the flight path information indicates a flight path of the UAV and includes one or more parameters related to the flight path of the UAV, and wherein said one or more reporting conditions for reporting the flight path information are that said one or more parameters have changed more than one or more threshold values within given one or more time intervals.

29. (canceled)

30. A network node, the network node being configured to:
transmit towards an unmanned aerial vehicle, UAV, reporting condition information which indicates one or more conditions for the UAV to report flight path information, wherein
the flight path information indicates a flight path of the UAV and includes one or more parameters related to the flight path of the UAV, and wherein said one or more reporting conditions for reporting the flight path information are that said one or more parameters have changed more than one or more threshold values within given one or more time intervals, and
the UAV comprises a wireless communication device, WCD, capable of communicating with the network node.

31. (canceled)
